(19) United States
(12) Patent Application Publication
(10) Pub. No.: US 2025/0168870 A1
(43) Pub. Date: May 22, 2025

(54) INTER-LINK INTERFERENCE MANAGEMENT FOR DATA LINK VIA COVERAGE ENHANCING DEVICE

(71) Applicant: Sony Group Corporation, Tokyo (JP)

(72) Inventors: Chaitanya TUMULA, Åkarp (SE); Erik BENGTSSON, Eslöv (SE); Jose FLORDELIS, Lund (SE); Fredrik RUSEK, Eslöv (SE); Kun ZHAO, Malmö (SE); Olof ZANDER, Södra Sandby (SE)

(21) Appl. No.: 18/841,068

(22) PCT Filed: Mar. 6, 2023
(86) PCT No.: PCT/EP2023/055602

§ 371 Date: Aug. 23, 2024

(30) Foreign Application Priority Data
Mar. 6, 2022 (SE) 2250300-7

(51) Int. Cl. H04W 72/541; H04W 24/10; H04W 72/12; H04W 72/27

(52) U.S. Cl. CPC H04W 72/541; H04W 24/10; H04W 72/12; H04W 72/27

(57) ABSTRACT

Inter-link interference, e.g., cross-link interference or remote interference, is managed in presence of a coverage enhancing device on a respective data link.

### TECHNICAL FIELD

Various examples of the disclosure generally relate to communicating between wireless communication nodes via a coverage enhancing device. Various examples of the disclosure specifically relate to interference management.

### BACKGROUND

To increase a coverage area for wireless communication, it is envisioned to use coverage enhancing devices (CEDs), particularly re-configurable relaying devices (RRD) or more particularly re-configurable reflective devices. Re-configurable reflective devices are sometimes also referred to as reflecting large intelligent surfaces (LISs). See, e.g., Huang, C., Zappone, A., Alexandropoulos, G. C., Debbah, M., & Yuen, C. (2019). Reconfigurable intelligent surfaces for energy efficiency in wireless communication. IEEE Transactions on Wireless Communications, 18(8), 4157-4170.

A CED can be implemented by an array of antennas that can reflect incident electromagnetic waves/signals. The array of antennas can be semi-passive. Semi-passive can correspond to a scenario in which the antennas can impose a variable phase shift and typically provide no signal amplification. Thereby, a spatial filter including at least one input beam and at least one output beam can be defined. By means of the spatial filter, electromagnetic waves can be steered or generally tailored. Thus, a data radio link (or simply data link) can be supported between two wireless communication nodes, e.g., a base station (BS) and a wireless communication device (terminal or user equipment, UE) or between two UEs.

### SUMMARY

There is a need for interference management when communicating on a data link that is via a CED.

This need is met by the features of the independent claims. The features of the dependent claims define embodiments.

A method of operating a first BS includes communicating at least one control message between the first BS and the second BS. The at least one control message is for interference management of an interference that is between a first data link and a second data link. The first data link is between the first BS and a first UE. The second data link is between the second BS and a second UE. The first data link is via a CED. The method also includes configuring a setting of one or more operational parameters of the CED in accordance with the at least one control message. The one or more operational parameters are associated with the first data link.

A computer program or a computer-program product or a computer-readable storage medium includes program code. The program code can be loaded and executed by at least one processor. Upon executing the program code the at least one processor performs a method of operating a first BS. The method includes communicating at least one control message between the first BS and the second BS. The at least one control message is for interference management of an interference that is between a first data link and a second data link. The first data link is between the first BS and a first UE. The second data link is between the second BS and a second UE. The first data link is via a CED. The method also includes configuring a setting of one or more operational parameters of the CED in accordance with the at least one control message. The one or more operational parameters are associated with the first data link.

A first BS includes a processor and a memory. The processor, upon loading and executing program code from the memory, is configured to communicate at least one control message between the first BS and the second BS. The at least one control message is for interference management of a an interference between a first data link and a second data link. The first data link is between the first BS and the first UE. The second data link is between the second BS and the second UE. The first data link is via a CED. The processor is further configured to configure a setting of one or more operational parameters of the CED in accordance with the at least one control message. The one or more operational parameters are associated with the first data link.

A method of operating a second BS includes communicating, between the second BS and a first BS, at least one scheduling control message for interference management of an interference between a first data link and a second data link. The first data link is between the first BS and a first UE. The second data link is between the second BS and a second UE. The first data link is via a CED. The scheduling control message is indicative of a timing of multiple distinct measurement occasions for which the first BS configures multiple test settings of one or more operational parameters of the CED. The method further includes triggering interference measurements of the interference during the multiple distinct measurement occasions.

A computer program or a computer-program product or a computer-readable storage medium includes program code. The program code can be loaded and executed by at least one processor. Upon executing the program code the at least one processor performs a method of operating a second BS. The method includes communicating, between the second BS and a first BS, at least one scheduling control message for interference management of an interference between a first data link and a second data link. The first data link is between the first BS and a first UE. The second data link is between the second BS and a second UE. The first data link is via a CED. The scheduling control message is indicative of a timing of multiple distinct measurement occasions for which the first BS configures multiple test settings of one or more operational parameters of the CED. The method further includes triggering interference measurements of the interference during the multiple distinct measurement occasions.

A second BS includes a processor and a memory. The processor, upon loading and executing program code from the memory, is configured to communicate, between the second BS and a first BS, at least one scheduling control message for interference management of an interference between a first data link and a second data link. The first data link is between the first BS and a first UE. The second data link is between the second BS and a second UE. The first data link is via a CED. The scheduling control message is indicative of a timing of multiple distinct measurement occasions for which the first BS configures multiple test settings of one or more operational parameters of the CED. The processor is further configured to trigger interference measurements of the interference during the multiple distinct measurement occasions.

A method of operating a first communication node includes communicating, between the first wireless communication node and a third wireless communication node, at least one control message for interference management of an interference between a first data link between the first wireless communication node and a second wireless communication node and a second data link between a third wireless communication node and a fourth wireless communication node, the first data link being via a coverage enhancing device. The method also includes, based on the at least one control message, configuring a setting of one or more operational parameters of the coverage enhancing device that are associated with the first data link.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a communication system including a base station and a wireless communication device according to various examples.

FIG. 2 schematically illustrates details of the communication system of FIG. 1.

FIG. 3 schematically illustrates a communication system including the base station, the wireless communication device, and a coverage enhancing device according to various examples.

FIG. 4 schematically illustrates the coverage enhancing device according to various examples.

FIG. 5 schematically illustrates an example scenario of inter-link interference for the communication system according to FIG. 3.

FIG. 6 illustrates various time-division duplex slot configuration settings.

FIG. 7 schematically illustrates an example scenario of inter-link interference for the communication system according to FIG. 3.

FIG. 8 is a flowchart of a method according to various examples.

FIG. 9 is a flowchart of a method according to various examples.

FIG. 10 is a signaling diagram according to various examples.

FIG. 11 is a signaling diagram according to various examples.

FIG. 12 is a signaling diagram according to various examples.

FIG. 13 is a signaling diagram according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which coact with one another to perform operation(s) disclosed herein. In addition, any one or more of the electrical devices may be configured to execute a program code that is embodied in a nontransitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between wireless communication nodes (or, simply, nodes). A wireless communication system includes two or more wireless communication nodes, e.g., implemented by a BS and one or more UEs. Another example would pertain to two UEs communicating with each other, e.g., using device-to-device communication. In some examples, the wireless communication system can be implemented by a wireless communication network, e.g., a radio-access network (RAN) of a Third Generation Partnership Project (3GPP)-specified cellular network (NW).

According to various examples, two nodes can communicate via a CED. This means, that a data link between two nodes can be supported by the CED. Electromagnetic waves travel via the CED and are affected by a spatial filter of the CED.

The CED may include an antenna array. The CED may include a meta-material surface. In examples, an CED may include a reflective antenna array (RAA). Various antenna elements of an antenna array or a meta-material surface can operate coherently and impose an antenna-element-specific phase shift.

Hereinafter, techniques will be disclosed that facilitate interference management of interference that is associated with communication along a data link that is via a coverage enhancing device. According to various examples, inter-link interference can be mitigated by appropriate interference management. Some examples of inter-link interference include cross-link interference and remote interference.

Cross-link interference (CLI) management is a new feature that was introduced in 3GPP release-16 to handle the interference caused by the dynamic time-division duplex (TDD) slot configuration in new radio systems, see 3GPP Technical Specification (TS) 38.300 V16.7.0, section 17.2; also see 3GPP TS 38.331 V 16.6.0, ReportConfigNR information element. Also see WO2021173235A1. Cross-link interference mainly occurs as the TDD slot configurations across different cells of one or more cellular networks (NWs) are not synchronized leading to misalignment of DL and UL symbols in slot configurations of respective cells or slot configurations associated with certain UEs in respective cells. The UEs in a cell can be configured to monitor such interference and report to the BSs. The reports can be event based or periodic reporting.

Similarly, remote interference (RI) management was introduced in 3GPP release-16 to handle interference caused due to atmospheric conditions, see 3GPP TS 38.300 V16.7.0, section 17.1. Here, coordinated BSs align or modify their TDD configurations to minimize the interference in the system.

Two types of inter-link interference for a CED scenario are summarized in TAB. 1 below.

TABLE 1
Multiple scenarios for inter-link interference.
Both scenarios are addressed in this disclosure.

| | SCENARIO | EXAMPLE DETAILS |
|---|---|---|
| I | Inter-link interference from | It would be possible that a node transmits towards a |
| | CED-supported data link | CED on a data link that is supported by the CED and |
| | to other data link | this transmission and/or the CED operation injects |
| | | inter-link interference into another data link. For |
| | | instance, a UE that is served by a BS using the other |
| | | data link may experience the inter-link interference |
| | | when attempting to receive signals from the BS. |
| II | Inter-link interference from | It would be possible that a node, e.g., a UE, |
| | other data link to CED- | transmits on a data link and this transmission injects |
| | supported data link | interference into a data link that is via a CED, i.e., |
| | | supported by the CED. For instance, a UE that is being |
| | | served by a BS using a data link that is supported by |
| | | the CED may monitor for signals on the data link and |
| | | may experience such inter-link interference. |

Typically, when CLI and/or RI exists in the communication system, BSs coordinate and modify the TDD slot configurations such that CLI or RI can be reduced. When CEDs are used, the BS can indicate, according to examples described herein, to the CED a change in the TDD slot configuration based on the received CLI or RIM messages.

However, the TDD slot configuration is only one operational parameter that can have an impact on to the inter-link interference. Alternatively or additionally to the TDD slot configuration, it would be possible to adjust the setting of the operational parameters, e.g., transmit power, phase, signal gain at the CED, to give just a few examples.

Hence, according to the disclosure, it is possible to communicate, between a first BS and the second BS, at least one control message of interference management of interference between a first data link between the first BS and the first UE and a second data link between the second BS and a second UE, i.e., inter-link interference. The first data link is via a CED. Based on the at least one control message, it is then possible to configure a setting of one or more operational parameters of the CED, these one or more operational parameters being associated with the first data link.

This concept can be extended to scenarios where the first data link and/or the second data link are not between a respective BS and a respective UE. More generally, it would be possible to communicate between a first node and a third node at least one control message for interference management of an interference between a first data link between the first node and a second node and a second data link between the third node and a fourth node. The first data link is via the CED. Then, based on the at least one control message, a setting of one or more operational parameters of the CED that are associated with the first data link can be configured. For the sake of simplicity, hereinafter, scenarios will be specifically described in the context of data links between BSs and UEs.

According to various examples, one or more BSs can coordinate to determine whether CLI and/or RI is due to UE transmission or rather operation of a CED, e.g., reflection from a CED, and take necessary actions. Strategies for determining whether the inter-link interference is caused by operation of the CED or transmission by the UE will be disclosed.

For instance, it would be possible to configure, during multiple distinct measurement occasions, multiple test settings of the one or more operational parameters of the CED. The at least one control message can then include at least one measurement report that is communicated from the second BS of the second UE to the first BS. The at least one measurement report is indicative of an interference level of the interference for a least one of the multiple distinct measurement occasions.

Here, by using the multiple test settings, the impact of the test settings on the inter-link interference can be probed/tested. The relative impact on the inter-link interference can be probed. Thereby, the inter-link interference can be linked to originate primarily from the CED or the first UE, or from both. I.e., the root node of the inter-link interference can be determined.

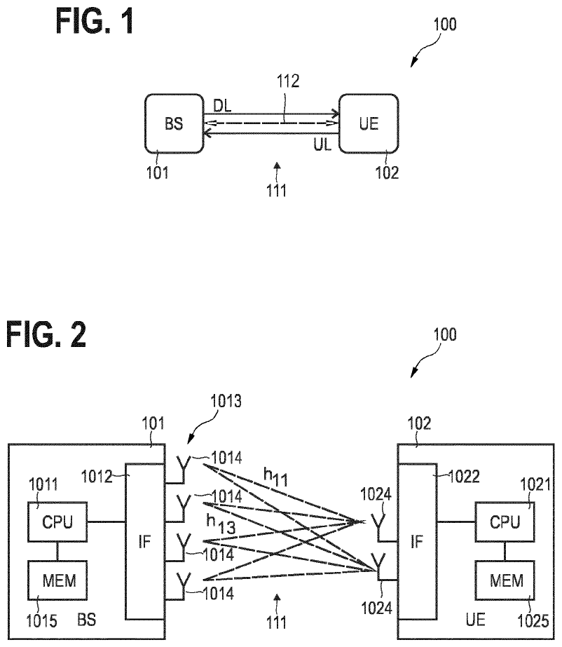

FIG. 1 schematically illustrates a communication system 100. The communication system includes two nodes 101, 102 that are configured to communicate with each other via a data carrier 111. In the example of FIG. 1, the node 101 is implemented by an access node, more specifically a BS, and the node 102 is implemented by a UE. The BS 101 can be part of a cellular NW (not shown in FIG. 1).

As a general rule, the techniques described herein could be used for various types of communication systems, e.g., also for peer-to-peer communication systems, etc. For the sake of simplicity, however, hereinafter, various techniques will be described in the context of a communication system that is implemented by a BS 101 of a cellular NW and a UE 102.

As illustrated in FIG. 1, there can be DL communication, as well as UL communication. Sometimes, DL communication suffers from inter-link interference caused by UL transmission (cf. TAB. 1).

The UE 102 and the BS 101 can communicate on the data carrier 111. For instance, the data carrier 111 may have a carrier frequency of not less than 20 GHz or even not less than 40 GHz. The data carrier 111 may be via an CED (not illustrated in FIG. 1).

Specifically, a data link 112 can be implemented on the data carrier 111. The data link 112 can include one or more logical channels that define a time-frequency resource grid. The data link 112 can be established, e.g., based on a random-access procedure of the UE 102, e.g., responsive to paging.

FIG. 2 illustrates details with respect to the BS 101. The BS 101 implements an access node to a communications network, e.g., a 3GPP-specified cellular network. The BS 101 includes control circuitry that is implemented by a processor 1011 and a non-volatile memory 1015. The processor 1011 can load program code that is stored in the memory 1015. The processor 1011 can then execute the program code. Executing the program code causes the processor to perform techniques as described herein, e.g.: transmitting and/or receiving (communicating) payload data on the data link 112 on the data carrier 111, e.g., via an CED (not shown in FIG. 2); participating in interference management of cross-link interference; configuring a setting of one or more operational parameters of a CED; configuring one or more operational parameters of a UE; configuring multiple test settings for the CED during multiple distinct measurement occasions; etc.

FIG. 2 also illustrates details with respect to the UE 102. The UE 102 includes control circuitry that is implemented by a processor 1021 and a non-volatile memory 1025. The processor 1021 can load program code that is stored in the memory 1025. The processor can execute the program code. Executing the program code causes the processor to perform techniques as described herein, e.g.: transmitting and/or receiving (communicating) payload data on the data link 112 on the data carrier 111, e.g., via an CED (not shown in FIG. 2); reconfigure one or more operational parameters as part of interference management; etc.

FIG. 2 also illustrates details with respect to communication between the BS 101 and the UE 102 on the data carrier 111. The BS 101 includes an interface 1012 that can access and control multiple antennas 1014. Likewise, the UE 102 includes an interface 1022 that can access and control multiple antennas 1024.

While the scenario of FIG. 2 illustrates the antennas 1014 being coupled to the BS 101, as a general rule, it would be possible to employ transmit-receive points (TRPs) that are spaced apart from the BS.

The interfaces 1012, 1022 can each include one or more TX chains and one or more RX chains. For instance, such RX chains can include low noise amplifiers, analogue to digital converters, mixers, etc. Analogue and/or digital beamforming would be possible. Thereby, phase-coherent transmitting and/or receiving (communicating) can be implemented across the multiple antennas 1014, 1024. Multi-antenna techniques can be implemented.

By using a TX beam, the direction of signals transmitted by a transmitter of the communication system is controlled. Energy is focused into a respective direction or even multiple directions, by phase-coherent superposition of the individual signals originating from each antenna 1014, 1024. Thereby, a spatial data stream can be directed. The spatial data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

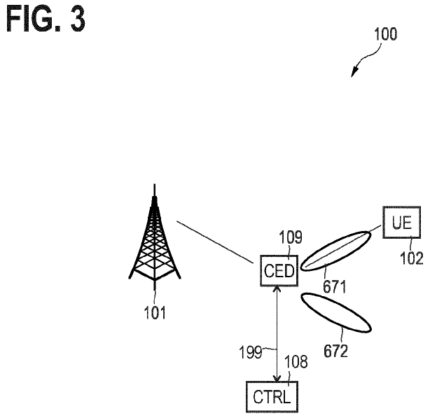

FIG. 3 illustrates aspects with respect to communicating via a CED 109. A UE 102 is served by the BS 101 via a CED 109. Different steering vectors define beams 671-672; only beam 671 is directed towards the UE 102. A spatial filter used at the CED 109 can address one of those two steering vectors or sometimes also both steering vectors.

Also illustrated in FIG. 3 is a control node 108 that can communicate with the CED 109 on a control link 199.

The control node 108 is generally optional.

While the control node 108 is shown as a separate device, it would be possible that the control node 108 is implemented as a functionality of the BS 101.

Hereinafter, a scenario is assumed in which the BS 101 implements the control node 108 for the CED 109. For instance, this means that the BS 101 can configure an appropriate TDD slot configuration so that different spatial filters would be activated at the CED 109 depending on the particular slot. Where a separate control node 108 is used, the BS 101 can inform the separate control node 108 to implement a respective TDD slot configuration.

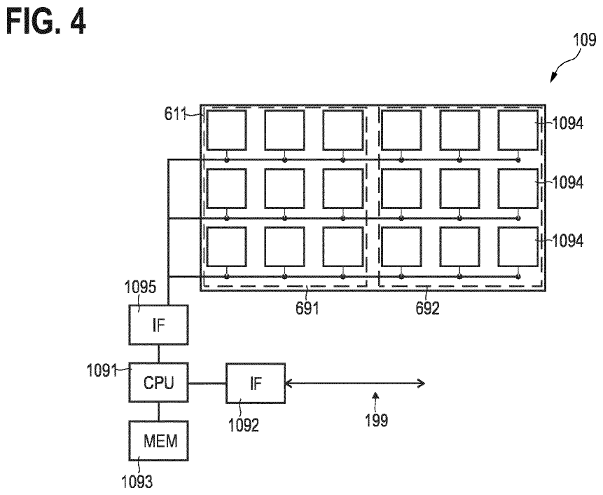

FIG. 4 illustrates aspects in connection with the CED 109. The CED 109 includes an array of antenna elements 1094—e.g., antennas or meta-material unit cells—each imposing a respective configurable phase shift when reflecting incident electromagnetic waves; this defines a respective spatial filter. The array of antenna elements 1094 in the illustrated example is passive, i.e., the antenna elements 1094 may not be able to provide signal amplification. This array of antenna elements 1094 forms a reflective surface 611. Typically, antennas can impose gradually varying phase shifts; while meta-material unit cells may, in some examples, be configured to provide only a set of phase shifts with a higher degree of quantization if compared to antennas, e.g., one of two phase shifts, e.g., such as +90° or −90°, or 0° and +180° (“1-bit setting”). Each antenna element 1094 can locally provide a respective phase shift, i.e., each antenna element 1094 may be individually configured.

The (re-)configuration of antenna elements 1094 defines respective spatial filters that are associated with spatial directions into which incoming electromagnetic waves are reflected, i.e., on a macroscopic level. This defines the spatial direction into which an outgoing beam 671-672 (cf. FIG. 3) is reflected.

The CED 109 includes an antenna interface 1095 and a processor 1091 that can activate respective spatial filters one after another.

Further, there is a communication interface 1092 such that communication on a control link 199 can be established between the CED 109 and a remote node, e.g., the BS 101 or the control node 108 (cf. FIG. 3). Example implementations of the control link 199 include, e.g., a Wi-Fi protocol or a Bluetooth protocol. Out-of-band signaling may be used with respect to the communication of payload data on the data link via the antenna elements. The control link 199 could also be implemented using the same communication protocol used for communication payload data; e.g., a separate bandwidth part may be used for the control link 199. In-band signaling may be used. The same or different bandwidth parts may be used for the communication of payload data via the antenna elements and the auxiliary link. A wired connection would be possible. The control link 199 can be used to assist an interference management procedure for mitigating inter-link interference.

The processor 1091 can load program code from a non-volatile memory 1093 and execute the program code. Executing the program code causes the processor to perform techniques as described herein, e.g.: re-configuring each one of the antenna elements 1094 to activate one of multiple spatial filters, e.g., in accordance with a TDD slot configuration; applying a setting of one or more operational parameters; etc.

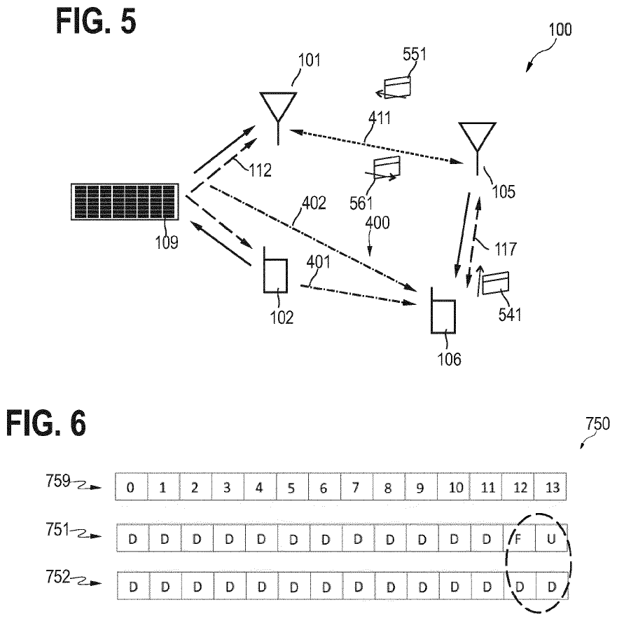

Next, aspects with respect to inter-link interference will be discussed in connection with FIGS. 5 and 6.

FIG. 5 schematically illustrates aspects with respect to a communication system 100 that includes a BS 101 and a UE 102 that communicate on a data link 112 via a CED 109; and further includes a BS 105 and a UE 106 that communicate on a data link 117. The BS 105 can be configured similarly to the BS 101, as explained above in connection with FIG. 2. The UE 106 can be configured similarly to the UE 102, as explained above in connection with FIG. 2.

The BS 101 and the BS 105 are time synchronized. I.e., symbol start times are aligned.

FIG. 5 generally corresponds to TAB. 1: scenario I.

FIG. 5 illustrates a scenario in which UL data is communicated on the data link 112. The inter-link interference can have a component 401 that is caused by the UE 102 transmitting on the data link 112; and/or can have a component 402 that is caused by the CED 109 applying a certain spatial filter to the incident electromagnetic waves.

The inter-link interference having the components 401, 402 is injected into the data link 117 and can, specifically, cause interference to reception of the UE 106.

One possible reason for inter-link interference can be different TDD slot configurations used on the data links 112, 117, respectively.

If the two BSs 101, 105 belong to different operators, they typically have different TDD slot configurations used in their respective cells. Even if the BSs 101, 105 belong to the same operator, the two cells might use different TDD slot configurations based on the traffic in their respective cells. Also, as supported in 3GPP NR specification, a UE might request a specific TDD slot configuration that may not be aligned with TDD slot configuration of UEs in the same cell or UEs in a different cell.

As a general rule, the TDD slot configuration may define UL and DL slots that have a duration of Orthogonal Frequency Division Multiplexing (OFDM) symbols or groups of OFDM symbols.

For instance, referring to FIG. 6, it could be assumed that BS 101 uses a first setting 751 of the TDD slot configuration 750 (here, either DL slots—labeled “D”—, or UL slots—labeled “U”—, or flexible slots—labeled “F” are assigned to OFDM symbols having different symbol indices 759) for communicating on the data link 112. For instance, the first setting 751 may be either a default setting of the TDD slot configuration of the BS 101 or UE specific setting of the TDD slot configuration associated with the UE 102. Similarly, the BS 105 uses a second setting 752 of the TDD slot configuration 750, to serve the UE 106 (only DL symbols).

Since CED 109 is configured by BS 101 to serve UE 102, the BS 101 needs to indicate the information associated with the setting 751 to the CED 109. This is for example done by the BS 101 providing a respective configuration message on the control link 199 (cf. FIG. 4). In accordance with such configuration message, the CED 109 can for example adjust settings of one or more operation parameters—e.g., spatial filter, gain settings, phase setting—depending on whether it is reflecting the signals in DL or UL at any given time.

Due to misaligned DL and UL symbols in the two settings 751, 752, the UE 106 might experience an inter-link interference from the UL symbols “12” and “13” when the UE 102 communicates with the BS 101 (dashed line in FIG. 6). This interference can be dominated by one of the two components 401, 402.

FIG. 6 only illustrates two example settings of the TDD slot configuration. Other settings of the TDD slot configuration are possible. The intention of FIG. 6 is merely to indicate the impact of deviating transmission directions on the inter-link interference.

Now referring back to FIG. 5.

The UE 106 can measure the inter-link interference 400 and report to the BS 105. A measurement report 541 can be transmitted. The measurement report 541 can be an event based or a periodic reporting.

When the BS 105 receives the measurement report 541 from the UE 106 and judges that the level of the interference 400 is high, the BS 105 communicates with the BS 101 over a backhaul link 411. This backhaul link 411 can employ a predefined wired or wireless interface.

A measurement report 551—a control message for interference management—that is sent by the BS 105 may contain the measured level of the interference 400 and optionally the setting 752 of the TDD slot configuration 750 used for communicating on the data link 117. The measurement report 551 is thus associated with RI and/or CLI.

After receiving the measurement report 551 from the BS 105, the BS 101 can change the setting 751 of the TDD slot configuration 750 used for the data link 112. For example, it can change from the setting 751 to the setting 752. The UE 102 and the CED 109 are re-configured accordingly, e.g., using DL control information (DCI) or radio resource control (RRC) signaling. Sometimes, it can be desirable to resolve whether the interference 400 is primarily caused by the component 401 or the component 402. For instance, it may be desirable to judge the strength of component 401 and/or the strength of component 402, e.g., relatively with respect to each other. It can be helpful to make such analysis to determine whether a setting of one or more operational parameters is primarily to be reconfigured at the CED 109 or at the UE 102. This analysis of the root cause of the inter-link interference 400 can be facilitated by the BS 101 configuring, during multiple distinct measurement occasions associated with UE 106, multiple test settings of one or more operational parameters of the CED 109. For instance, a first setting can be associated with a power-off state of the CED 109.

The BS 101 then provides a scheduling control message indicative of the timing associated with the multiple settings to the BS 105 (it would be generally possible that the scheduling control message is provided from the BS 105 to the BS 101). Based on the scheduling control message, the BS 105 triggers interference measurements of the interference 400 during the measurement occasions. This can include allocating measurement resources for the UE 106. Each of the measurement resources is associated with a respective test setting.

The BS 105 then obtains the measurement report 541 associated with the distinct measurement occasions. The BSs 101, 105 can then determine whether the component 401 dominates or whether the component 402 dominates the interference 400. I.e., based on the measurement report 541 it is possible to determine whether the inter-link interference 400 is caused by operation of the CED 109 or by transmission of the UE 102.

If the interference 400 is primarily caused by the CED 109 (component 402), the BS 101 can configure a respective setting to mitigate the interference 400, e.g., using a spatial filter that has an output beam directed away for the UE 106. If the interference 400 is primarily caused by the UE 102, a different setting of the TDD slot configuration can be used.

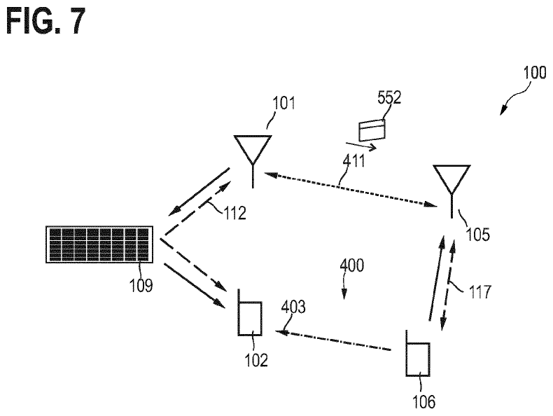

Another scenario of the inter-link interference 400 is shown in FIG. 7.

FIG. 7 generally corresponds to FIG. 5, however relates to scenario II of TAB. 1 (rather than scenario I).

If the BS 101 uses the setting 752 of the TDD slot configuration 750 for communicating on the data link 112 and BS 105 uses the setting 751 of the TDD slot configuration 750 for communicating on the data link 117, then UL transmissions from 106 can interfere with the DL reception at 102. A respective component 403 of the inter-link interference 400 is illustrated in FIG. 7. In this case, the UE 102 can measure the level of the interfere 400 and report to the BS 101. The BS 101 then coordinates with the BS 105 using a respective control message 552, and BS 105 change the TDD setting from 752 to the setting 751 for UE 106.

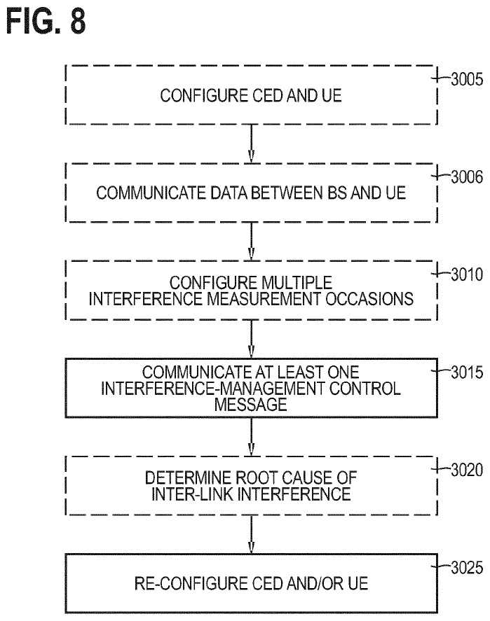

FIG. 8 pertains to a generalized framework for inter-link interference management, e.g., as specifically discussed in connection with FIG. 5, FIG. 6, and FIG. 7.

FIG. 8 is a flowchart of a method according to various examples. FIG. 8 illustrates aspects with respect to inter-link interference management of interference between two data links, wherein at least one of those two data links is via a CED. The inter-link interference can pertain to CLI and/or RI. Scenarios I and II of TAB. 1 can be managed.

The method of FIG. 8 can be implemented by a first BS communicating with a first UE on a first data link, the first data link being supported by a CED. For example, the method of FIG. 8 could be implemented by the BS 101 of the communication system 100 discussed in connection with FIG. 5 and FIG. 7. Specifically, it would be possible that the method of FIG. 8 is executed by the processor 1011 upon loading program code from the memory 1015 and upon executing the program code.

The first BS could be implemented by the BS 101 and the first UE could be implemented by the UE 102.

Inter-link interference can be observed between the first data link and a second data link between a second BS and a second UE, e.g., the BS 105 and the UE 106 (cf. FIG. 5 and FIG. 7). Optional boxes are illustrated using dashed lines in FIG. 8.

At optional box 3005, an initial setting of one or more operational parameters of the CED is configured. These one or more operational parameters are associated with the first data link that is supported by the CED.

Example operational parameters for which settings can be configured are summarized below in TAB. 2.

TABLE 2
Operational parameters that can be set at the CED
to mitigate and/or probe inter-link interference.

| OPERATIONAL | |
|---|---|
| PARAMETER | EXAMPLE DESCRIPTION |
| TDD slot | The TDD slot configuration can specify, on a slot-by-slot basis, |
| configuration | whether certain symbols are allocated for UL data or DL data or |
| | can be flexibly assigned to either UL data or DL data, e.g., from |
| | OFDM symbol to OFDM symbol. |
| | An example slot configuration 750 has been discussed above in |
| | connection with FIG. 6. |
| | The TDD slot configuration defines a BS or a UE are allowed to |
| | transmit at a given slot, e.g., at a given OFDM symbol. The CED |
| | may apply different spatial filters depending on the slot, e.g., |
| | depending on the symbol; or, under the assumption of reciprocity, |
| | may use a fixed spatial filter that uses beams directed to the BS |
| | and the UE, wherein similar beams can be used for UL and DL. |
| | Using different TDD slot configurations, inter-link interference can |
| | be impacted, because different nodes will access the spectrum in |
| | different directions (UL or DL). |
| Spatial filter | The particular spatial filter used at the CED can be set. Different |
| | spatial filters can be associated with different beams; such that |
| | different spatial characteristics of radiation at the CED result. |
| | By using different spatial filters, inter-link interference can be |
| | increased or decreased, because the spectrum is accessed using |
| | different spatial characteristics. |
| Gain | Sometimes, the CED may be able to apply amplification to incident |
| | electromagnetic waves. Alternatively or additionally, CED may be |
| | able to apply variable damping to incident electromagnetic waves. |
| | A gain can be used to tailor such properties. |
| Phase | A global phase shift may be applied to incident electromagnetic |
| | waves at the CED. This phase shift can be tailored by means of a |
| | setting pertaining to phase. |

Further, one or more operational parameters affecting the communication on the respective first data link can be set at the first UE. Such parameters could pertain to transmit power or TDD slot configuration or transmit beam or receive beam.

At box 3006, it would then be possible to communicate data on the first data link between the first BS and the first UE, wherein data link is supported by the CED. The settings of the one or more operational parameters of the CED and the one or more operational parameters of the UE as configured at box 3005 are used.

It would be possible, at box 3010, to configure multiple interference measurement occasions, all associated with the second UE. These can be associated with different test settings of the one or more operational parameters of the CED (cf. TAB. 2).

For instance, at least one of the test settings can pertain to the settings of the one or more operational parameters configured for operation at box 3005.

It would also be possible to configure test settings that differ from the setting as configured at box 3005.

By configuring multiple test settings at multiple distinct measurement occasions, interference measurements can be collected for the multiple distinct measurement occasions; and based on a comparison between such measurement reports, it can be judged whether the root source for inter-link interference is the CED or the or the first UE (cf. TAB. 1: scenario I; FIG. 5).

Sometimes, multiple interference measurement occasions may not be configured, e.g., where scenario II of TAB. 1 is addressed.

At box 3015, at least one interference-management control message is communicated between the first BS and the second BS.

According to various examples, various interference-management control messages may be communicated. Some examples are described below in TAB. 3.

TABLE 3
Various implementations of interference-management control
messages that are communicated between the first BS and
the second BS, e.g., in a respective backhaul link.

| | CONTROL | |
|---|---|---|
| | MESSAGE | EXAMPLE DESCRIPTION |
| I | Scheduling | For instance, where multiple test settings are configured at |
| | control | multiple distinct measurement occasions at box 3010, it would |
| | message | be possible to indicate these multiple distinct measurement |
| | | occasions, at box 3010, to the second BS. A respective |
| | | scheduling control message that is indicative of the timing of the |
| | | measurement occasions can be communicated. |
| | | As a general rule, such scheduling control message could be |
| | | communicated from the second BS to the first BS (in which |
| | | case box 3015 could be at least partially executed prior to box |
| | | 3010); alternatively, such scheduling control message could be |
| | | communicated from the first BS to the second BS. |
| II | Measurement | The at least one interference-management control message |
| | report | can also include a measurement report of the inter-link |
| | | interference or even multiple measurement reports that are indicative |
| | | of an interference level of the inter-link interference at the |
| | | second data link caused by communicating on the first data link |
| | | (cf. FIG. 5 measurement report 551). |
| | | Such measurement report may be provided by a respective BS |
| | | or directly by a UE. |
| | | Specifically, such at least one measurement report could be |
| | | indicative of the interference level of the inter-link interference for |
| | | a least one of multiple measurement occasions, as configured |
| | | at box 3010. |
| | | For instance, the interference level of the inter-link interference |
| | | could be resolved for different reoccurring resources. For |
| | | instance, the interference level of the inter-link interference |
| | | level could be resolved for different symbols of a TDD slot |
| | | configuration. Then, it would be possible to take this time |
| | | dependency of the inter-link interference into account when |
| | | reconfiguring, e.g., the setting of the TDD slot configuration. |
| III | Requested | Sometimes, it may not be required to exchange measurements |
| | setting | of the interference between the first BS and the second BS. |
| | | Rather, it would be possible to request a certain setting of one |
| | | or more operational parameters, e.g., a certain setting of the |
| | | TDD slot configuration. |

At box 3020, a root cause of the inter-link interference can be determined. Specifically, it would be possible to determine whether the inter-link interference is caused by operation of the CED or transmission of the first UE. This can be, in particular, applicable to the TAB. 1: scenario I; when multiple interference measurement occasions have been configured at box 3010.

As will be appreciated from the above, based on the impact of switching between different test settings of one or more operational parameters at the CED at multiple distinct measurement occasions, the root cause of the inter-link interference can be derived. In particular, the impact of the operation of the CED to support the data link between the first BS and the first UE can be estimated.

Sometimes, it can be helpful that at least one of the multiple test settings is associated with a power-off state of the CED. Such a power-off state can correspond to the antenna elements of the CED not imposing any coherent phase shifts on the incident electromagnetic waves. It is also possible that each antenna element of the CED is connected to a resistor (absorption) for power off mode. Thereby, in such a power-off state, the data link between the first BS in the first UE may not be supported by the CED. Using the power-off state can help to quantify the impact of the operation of the CED onto the inter-link interference.

It would be possible that at least one of the multiple test settings that are configured at box 3010 is associated with a frequency-translation operation of the CED. For instance, such frequency-translation operation can pertain to translating the frequency of incident electromagnetic waves to another frequency. For instance, nonlinear electromagnetic interactions can be used at the antenna elements. Thus, the carrier frequency of the data carrier (cf. FIG. 1: data carrier 111) to which the first BS and the first UE tune may differ from each other.

The root cause can be determined based on at least one measurement report that is communicated from the second BS to the first BS or even the second UE to the first BS. The at least one measurement report can be indicative of the interference level for at least one of the multiple measurement occasions.

A measurement report can include aggregated information for the multiple measurement occasions. It would also be possible to communicate multiple measurement reports for the multiple measurement occasions.

For instance, it would be possible that the at least one measurement report that is obtained by the first BS is indicative of a relative interference level of the inter-link interference during different ones of the multiple distinct measurement occasions. For instance, it would be possible that it is indicated whether the inter-link interference sensed by the second BS and/or the second UE increases or decreases in a second one of the multiple distinct measurement occasions with respect to a first one of the multiple distinct measurement occasions. Such impact of a test setting of the one or more operational parameters on the inter-link interference can be indicative of the CED being the root cause for the inter-link interference.

At box 3025, the setting of one or more operational parameters at the CED and/or the UE can be re-configured, i.e., changed with respect to the initial settings (as configured at box 3005).

For instance, the setting of the one or more operational parameters could be configured based on at least one measurement report obtained from the second BS, at box 3015.

For instance, it would be possible that the CED is conditionally re-configured responsive to the interference level of the inter-link interference being above a predetermined threshold.

In a further example, it could be determined whether the interference is injected into the second data link primarily by the CED, rather than the UE. Only in case the CED is the root cause for the inter-link interference, the CED may be re-configured at box 3025.

As a general rule, at box 3025, it would be possible to use a setting for the one or more operational parameters of the CED that is different from the test settings used at the multiple distinct measurement occasions. For example, it would be possible that the setting with which the CED is configured at box 3025 is inferred taking into consideration the interference level sensed at the various measurement occasions. For instance, an interpolation can be performed based on multiple test settings. In another example, it would also be possible that the setting of the one or more operational parameters used for re-configuring the CED at box 3025 corresponds to the selected one of the multiple test settings that has a minimum interference level of the inter-link interference.

Sometimes, a scenario may occur, where, at box 3025, additionally or alternatively to reconfiguring the CED at box 3025, a setting of one or more operational parameters of the UE is reconfigured, e.g., adjusted with respect to the setting of the respective one or more operational parameters initially set at box 3005. For instance, a scenario may be conceivable where, at box 3025, the CED is reconfigured to support another setting of a TDD slot configuration; then, this other setting of the TDD slot configuration may also be configured at the UE at box 3025 (also, it could be the other way around, i.e., UE TDD slot configuration changed first and then changed at the CED; also it could be changed at CED and UE at the same time using a single control message intended for both). In another example, it would be possible that, at box 3020, it is determined that the root cause of the inter-link interference is not the CED, but rather the UE. In such a scenario, it may suffice to reconfigure the UE. For instance, the transmit power of the UE may be reduced. For instance, different transmit beam for UL transmissions may be configured at the UE.

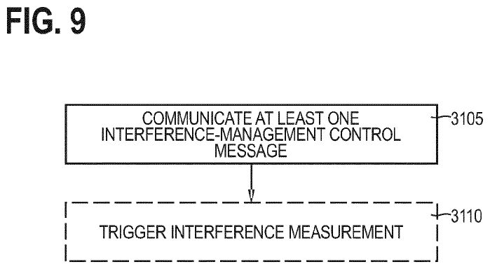

FIG. 9 is a flowchart of a method according to various examples.

FIG. 9 illustrates aspects with respect to inter-link interference management of interference between two data links, wherein at least one of those two data links is via a CED. The inter-link interference can pertain to CLI and/or RI. Scenarios I and II of TAB. 1 can be managed.

The method of FIG. 9 can be implemented by a second BS communicating with a second UE on a second data link. A first data link between a first BS and a first UE can be supported by a CED. For example, the method of FIG. 9 could be implemented by the BS 105 of the communication system 100 discussed in connection with FIG. 5 and FIG. 7. Specifically, it would be possible that the method of FIG. 9 is executed by a processor such as the processor 1011 upon loading program code from a memory such as the memory 1015 and upon executing the program code.

The second BS could be implemented by the BS 105 and the second UE could be implemented by the UE 106.

Optional boxes are illustrated using dashed lines in FIG. 9.

At box 3105, at least one interference management control message is communicated. Example content of such interference-management control messages has been discussed in connection with TAB. 3 above. For instance, it would be possible that the second BS provides, to the first BS, a scheduling control message that is indicative of a timing of multiple measurement occasions. Alternatively or additionally, it would be possible that the second BS, obtains, from the first BS, such a scheduling control message.

Box 3105 is inter-related to box 3015 of FIG. 8.

Then, at box 3110, the second BS can trigger interference measurements of the interference during multiple distinct measurement occasions, e.g., as indicated by such scheduling control message. For these multiple distinct measurement occasions, the first BS can configure the CED to implement different test settings of one or more operational parameters. For instance, a power-off state can be configured during one of those multiple distinct measurement occasions. Such aspects have been discussed in connection with box 3010 above.

Triggering the interference measurements at box 3110 can include executing the interference measurements locally and/or configuring the second UE to execute the interference measurements. Where the second UE is commanded to execute the interference measurements, a measurement report on multiple measurement reports for the distinct measurement occasions may be received and reported back to the first BS, e.g., in a further interference-management control message at box 3105. Sometimes, the second UE may report directly to the first BS.

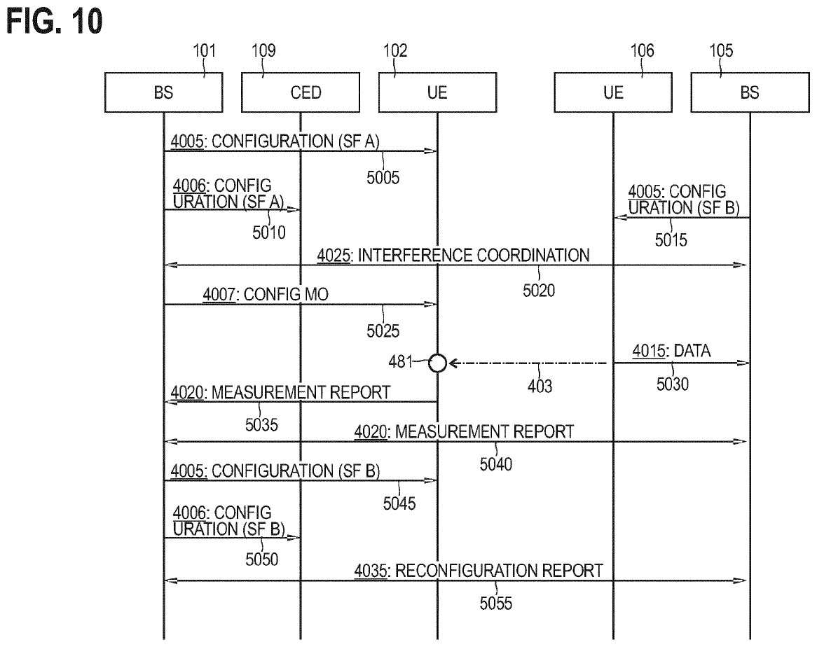

FIG. 10 is a signaling diagram of communication between the BS 101, the UE 102, the BS 105, and the UE 106. As discussed above in connection with, e.g., FIG. 5 and FIG. 7, the communication between the BS 101 and the UE 102 is via the data link 112 that is supported by the CED 109.

The signaling of FIG. 10 can implement the method of FIG. 8. The signaling of FIG. 10 can implement the method of FIG. 9.

The scenario of FIG. 10 generally corresponds to the scenario discussed above in connection with TAB. 1, scenario II and FIG. 7; i.e., a component 403 of the inter-link interference 400 that is injected into the data link 112 by the UE 106 transmitting to the BS 105 is measured.

At 5005, an initial setting of one or more operational parameters of the UE 102 is configured by the BS 101 using a respective configuration control message 4005.

At 5010, a configuration control message 4006 is provided by the BS 101 to the CED 109. For instance, one or more of the operational parameters as discussed above in connection with TAB. 1 could be configured. As illustrated in FIG. 10, it would be, specifically, possible to configure a setting of a TDD slot configuration, e.g., slot format “A”. 5005 and 5010 accordingly can implement box 3005 of the method of FIG. 8.

At 5015, the BS 105 provides to the UE 106 a respective configuration control message 4005 to configure a setting of one or more operational parameters at the UE 106. For instance, it would be possible to configure a setting of a TDD slot configuration, e.g., slot format “B”.

At 5020, and interference coordination is implemented between the BS 101 and the BS 105. For instance, one or more interference-management control messages may be exchanged between the BS 105 and the BS 101 that participate in an inter-link interference-management procedure. This could implement box 3015 and box 3105.

At 5025, the BS 101 provides to the UE 102 a measurement configuration message that configures a measurement occasion 481. For instance, the measurement occasion 481 may be configured based on scheduling information that is provided from the BS 101 to the BS 105 or vice versa at 5020 or separately (not shown).

During the measurement occasion 481, the UE 102 senses a signal level on the spectrum, to thereby quantify the component 403 of the inter-link interference 400 that is caused by the UE 106 transmitting data 4015 on the second data link to the BS 105 at 5030.

The UE 102, at 5035, provides a measurement report 4020 to the BS 101. It is optionally possible, at 5040, that the BS 101 provides to the BS 105 such measurement report 4020. This would implement box 3015.

The measurement report 4020 thus corresponds to the measurement report 552 (cf. FIG. 7). For example, if the interference level sensed at the measurement occasion 481 and as indicated in the measurement report 4020 exceeds a certain threshold, it would be possible to reconfigure the setting of the UE 102 using a respective configuration control message 4005, at 5045. Optionally, it would also be possible to reconfigure the setting of the CED 109 using a respective configuration control message 4006 at 5050. For instance, as illustrated in the scenario of FIG. 10, another setting of the TDD slot configuration may be implemented, e.g., the slot format “B”, to thereby mitigate the inter-link interference 400.

5045 and 5050 thus implement box 3025.

A respective interference-management control message 4035 reporting the re-configuration is then provided from the BS 101 to the BS 105, at 5055.

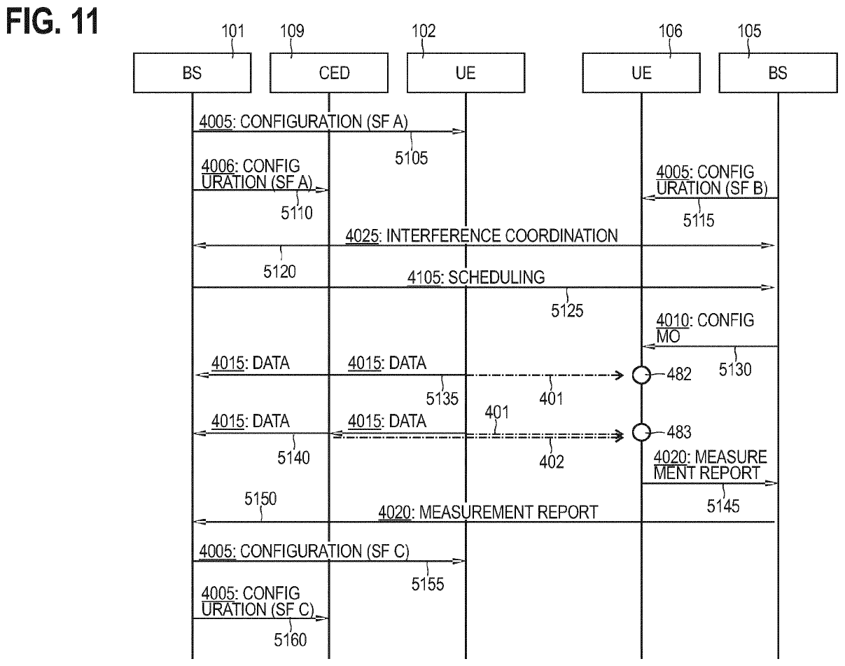

FIG. 11 is a signaling diagram of communication between the BS 101, the UE 102, the BS 105, and the UE 106. As discussed above in connection with, e.g., FIG. 5 and FIG. 7, the communication between the BS 101 and the UE 102 is via the data link 112 that is supported by the CED 109.

The signaling of FIG. 11 can implement the method of FIG. 8. The signaling of FIG. 11 can implement the method of FIG. 9.

The scenario of FIG. 11 generally corresponds to the scenario discussed above in connection with TAB. 1: scenario I, and FIG. 5; i.e., components 401 and 402 of the inter-link interference 400 are injected into the data link 117 by the UE 102 transmitting to the BS 101 and/or by operating the CED 109.

5105, 5110, 5115, and 5120 correspond to 5005, 5010, 5015, and 5020, respectively.

At 5125, the BS 101 provides to the BS 105 a scheduling control message 4105 that is indicative of a timing of two distinct measurement occasions 482, 483. Sometimes, the scheduling control message 4105 could also be exchanged as part of the interference coordination at 5120. 5125 thus implements box 3015 and box 3105.

At 5130, the BS 105 provides to the UE 106 a measurement configuration message 4010 that configures the two measurement occasions 482, 483.

During the measurement occasions 482, 483, the UE 102 transmits, at 5135 and 5140, to the BS 101 and, accordingly, the respective data 4015 communicated on the first data link 112 causes interference 400 at the UE 106. The specific interference components 401, 402 can be resolved by using different settings of one or more operational parameters at the CED 109 during the two distinct measurement occasions 482, 483. For instance, at 5135 the CED 109 is in a power-off state, so that there is no respective component 402 of the inter-link interference 400. By comparing the interference level sensed during the measurement occasions 482, 483, it would be possible to quantify the components 401, 402; then, the UE 106 provides a measurement report 4020 at 5145 to the BS 105 which provides the measurement report 4020 to the BS 101 at 5150. Also, direct UE reporting would be possible.

The BS 101 can then determine whether the predominant contribution to the inter-link interference 400 is the component 401 or the component 402. Depending on this finding, it would be possible to, e.g., reconfigure the CED 109 and/or the UE 102. At 5155 and 5160 similar reconfiguration as previously discussed in 5045 and 5050 is executed, as an example.

If the interference 400 is primarily caused by the CED 109 (component 402), the BS 101 can configure a respective setting to mitigate the interference 400, e.g., using a spatial filter that has an output beam directed away for the UE 106. If the interference 400 is primarily caused by the UE 102, a different setting of the TDD slot configuration can be used.

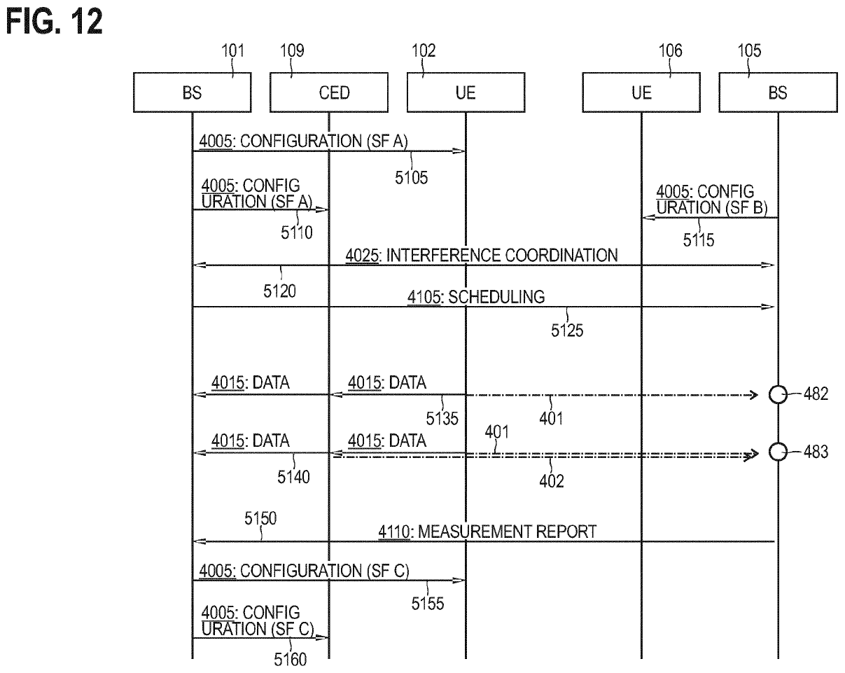

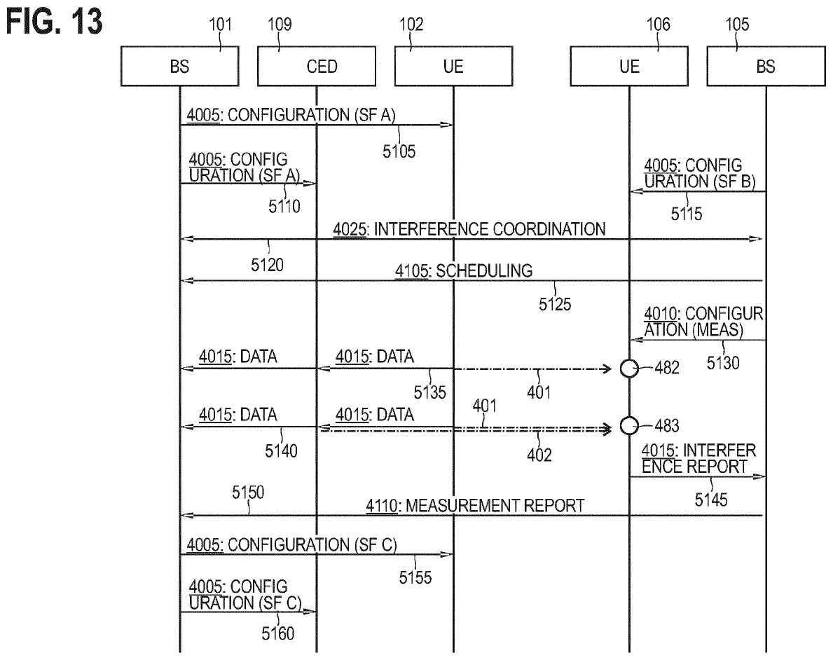

Variations of the signaling of FIG. 11 are possible. Such variations are illustrated in FIG. 12 in FIG. 13. For instance, in FIG. 12 the BS 105 locally implements the measurement occasions 482, 483. In FIG. 13, the scheduling control message 4105 is communicated from the BS 105 to the BS 101 at 5125.

For illustration, above, scenarios of inter-link interference management have been disclosed for two data links that are between respective BSs and UEs. However, as a general rule, inter-link interference management as disclosed above can also be applied to scenarios where a respective data link is between two UEs. Also, communication between two UEs can benefit from support by a CED or expose a BS-UE data link that is via a CED to inter-link interference.

1. A method of operating a first base station, the method comprising:
communicating, between the first base station and a second base station, at least one control message for interference management of an interference between a first data link between the first base station and a first wireless communication device and a second data link between the second base station and a second wireless communication device, the first data link being via a coverage enhancing device, and
in accordance with the at least one control message, configuring a setting of one or more operational parameters of the coverage enhancing device that are associated with the first data link.

2. The method of claim 1, further comprising:
configuring, during multiple distinct measurement occasions, multiple test settings of the one or more operational parameters of the coverage enhancing device,
wherein the at least one control message comprises at least one measurement report communicated from the second base station or the second wireless communication device to the first base station, the at least one measurement report being indicative of an interference level of the interference for at least one of the multiple distinct measurement occasions.

3. The method of claim 2,
wherein the setting of the one or more operational parameters is configured based on the at least one measurement report.

4. The method of claim 3,
wherein the setting of the one or more operational parameters is conditionally configured based on the at least one measurement report if the interference level of the interference for the at least one of the multiple distinct measurement occasions is indicative of the interference being injected into the second data link by the coverage enhancing device.

5. The method of claim 2,
wherein the at least one measurement report is indicative of a relative interference level of the interference during different ones of the multiple distinct measurement occasions.

6. The method of claim 2,
wherein the setting of the one or more operational parameters is different than the multiple test settings.

7. The method of claim 2,
wherein the setting of the one or more operational parameters corresponds to a selected one of the multiple test settings, the selected one of the multiple test settings having a minimum interference level of the interference.

8. The method of claim 2,
wherein one of the multiple test settings is associated with a power-off state of the coverage enhancing device.

9. The method of claim 2,
wherein at least one of the multiple test settings is associated with a frequency-translation operation of the coverage enhancing device.

10. The method of claim 2, further comprising:
based on the at least one measurement report, determining whether the interference is caused by operation of the coverage enhancing device or transmission of the first wireless communication device,
wherein the setting of the one or more operational parameters is determined based on said determining whether the interference is caused by operation of the coverage enhancing device or transmission of the first wireless communication device.

11. The method of claim 2,
wherein the at least one control message comprises a scheduling control message indicative of a timing of the multiple distinct measurement occasions.

12. The method of claim 11,
wherein the scheduling control message is communicated from the first base station to the second base station.

13. The method of claim 11,
wherein the scheduling control message is communicated from the second base station to the first base station.

14. The method of claim 1,
wherein the one or more operational parameters of the coverage enhancing device comprise a time-division duplex slot configuration.

15. The method of claim 1,
wherein the one or more operational parameters of the coverage enhancing device comprise a spatial filter.

16. The method of claim 1,
wherein the one or more operational parameters of the coverage enhancing device comprise a gain.

17. The method of claim 1,
wherein the one or more operational parameters of the coverage enhancing device comprise a phase.

18. The method of claim 1,
wherein the at least one control message is indicative of the interference level of the interference in at least one of multiple re-occurring resources,
wherein the one or more operational parameters of the coverage enhancing device are set for the at least one of the multiple re-occurring resources.

19-20. (canceled)

21. A method of operating a second base station, the method comprising:
communicating, between the second base station and a first base station, at least one scheduling control message for interference management of an interference between a first data link between the first base station and a first wireless communication device and a second data link between the second base station and a second wireless communication device, the first data link being via a coverage enhancing device, the scheduling control message being indicative of a timing of multiple distinct measurement occasions for which the first base station configures multiple test settings of one or more operational parameters of the coverage enhancing device, and
triggering interference measurements of the interference during the multiple distinct measurement occasions.

22-23. (canceled)

24. A first base station, comprising a processor configured to:
communicate, between the first base station and a second base station, at least one control message for interference management of an interference between a first data link between the first base station and a first wireless communication device and a second data link between the second base station and a second wireless communication device, the first data link being via a coverage enhancing device, and
in accordance with the at least one control message, configure a setting of one or more operational parameters of the coverage enhancing device that are associated with the first data link.

25-27. (canceled)
